(19) United States
(12) Patent Application Publication
(10) Pub. No.: US 2005/0263020 A1
(43) Pub. Date: Dec. 1, 2005

(54) Device for fitting a die sleeve to a die cylinder of a rotary cylinder press

(76) Inventors: Patrick Schoellhorn, Esslingen (DE); Martin Pahr, Dettingen/Erms (DE)

Correspondence Address: NATH & ASSOCIATES, PLLC, Sixth Floor, 1030 15th Street, N.W., Washington, DC, 20005, US

(21) Appl. No.: 11/135,536

(22) Filed: May 24, 2005

(30) Foreign Application Priority Data
May 26, 2004 (DE) 1020040268890.4

(51) Int. Cl. B41F 27/00

(52) U.S. Cl. 101/383

(57) ABSTRACT

In rotary embossing and printing machines, the printing dies are preferably fixed by means of a die sleeve (11) to the die cylinder (12). In order to be able to replace the die sleeve without dismantling the die cylinder, said sleeve is slotted and the mounting support of the die cylinder in the machine is so constructed that it can be drawn through and then reinserted through a side plate of the machine frame. It is then clamped to the die cylinder (12) and for this purpose use is made of a clamping device (14) in the slot (13) of die sleeve (11). Said clamping device is provided with clamp ledges (18) acting on the die sleeve and which are mutually clampable by means of numerous, axially mutually spaced clamps (35). The clamps (35) operate by means of bosses (30) axially displaceable under spring clamp on a central clamping drive shaft and connecting members (32) which reduce the spacing between the clamp ledges (13) by tilting and for the numerous clamps this takes place in parallelogram-like manner over the entire die cylinder length. Thus, by a single actuation from one of the front ends of the die cylinder, i.e. from the operation or drive side of the machine, clamping and relaxation can be effected.

The following disclosure is based on German Patent Application No. 10 2004 026 889.4 filed on May 26, 2004, which is herewith incorporated into this application by explicit reference.

### FIELD OF APPLICATION AND PRIOR ART

The invention relates to a device for fitting a die sleeve to a die cylinder of a rotary cylinder press, e.g. an embossing or printing machine, in which the die sleeve is replaceably clamped to the die cylinder.

DE 196 27 034 C2 describes in detail such a printing or embossing machine with a counterpressure or impression cylinder and a die cylinder, onto which is replaceably drawn a die or block sleeve. It carries the actual printing dies, which e.g. in the case of an embossing machine transfer surface portions from a support foil to the material to be printed and specifically in the printing gap between the die and the impression cylinder. In order to shorten the downtimes, the die sleeve is replaceable, in that the dies can in preparatory manner be fastened to the die sleeve. DE 196 27 034 describes an arrangement with which the die sleeve can be drawn off without dismantling a side plate of the machine frame, namely this takes place through said plate. The fixing of the die sleeve takes place by means of individual, hook-like fixing members.

U.S. Pat. No. 2,047,364 (Foster) describes a fixing unit for printing cylinders, which is located in a deep, undercut cylinder groove. It can be fastened from the front end of the cylinder. By means of a thread a push rod is moved along the cylinder and by means of in each case one spring acts on a sliding piece with a sloping rocker path in which is guided a roll. Thus, a fixing ledge is moved in the circumferential direction of the cylinder on which is located a fixing surface for one side of a block, which on the other side is suspended on the printing cylinder.

### OBJECT OF THE INVENTION

The object of the invention is to further improve such a device and develop the same so as to bring about simpler, faster operation.

This and other objects are solved by the invention.

### SUMMARY OF THE INVENTION

The assembly time is significantly reduced through the central clamping or tensioning drive operable from the front end (operation or drive side) of the die cylinder and the machine. This also makes it possible to ensure that fixing takes place with the same clamping or tensioning force over the entire die cylinder length.

The clamping or tensioning device is a functionally closed, removable chamber in which the die cylinder does not have to functionally or constructionally intervene. It can be used for different die cylinders and/or sleeves. No problems are encountered when using differently designed and dimensioned die sleeves, e.g. as a result of clamping devices of different widths.

As a result of the bilateral connection to the die sleeve a symmetrically acting clamping force is produced, which avoids a tensioning force reduction on one side of the die sleeve as a result of friction, etc.

The preferred construction with a clamp extending over the entire die cylinder length operating by means of gripping devices in the clamp ledges engaging adjacent to the die sleeve slot, prevents non-uniform loads and distributes the forces uniformly over the die cylinder length. Clamping preferably takes place by means of a clamping drive element, which is guided with a motion-transmitting thread in a bridge axially connected to the clamp ledges and which is consequently axially displaced under tension. Collars on this element constructed similar to a shaft press on disk spring sets, which in turn are displaced in boss-axial manner on the clamping drive shaft. The bosses are connected to connecting members articulated on one side to the boss and on the other side to the clamp ledges, so that in the case of a displacement of the bosses the connecting members running initially precisely in the circumferential direction are tilted, so as to reduce the spacing between the clamp ledges and reduce the slot in the die sleeve, which clamps the latter on the die cylinder. The displacement of the bosses by means of interposed spring elements ensures that in the case of an identical design of said springs, all the many clamps comprising boss and connecting springs are drawn with the same force onto the clamp ledges and consequently there is no risk of a deflection of the latter. As a result of the toggle lever or connecting rod-like construction of the connecting members and the rotary mounting thereof, the clamping device can have a particularly shallow construction, so that it projects scarcely over the space formed by the slot and also not into the die cylinder.

Numerous variants are possible to this particularly simple, appropriate construction, which largely operates with swivel joints, so that there is virtually no jamming risk and friction is limited. Thus, e.g. in place of the axial displacement of the clamping drive shaft by means of a single motion-transmitting thread on the bridge, there could be numerous individual motion-transmitting nuts on the shaft, which press on the spring elements and consequently displace the bosses. It is also possible to have different clamping device constructions which contract the clamp ledges by means of a central actuation, e.g. cams located on the clamping drive shaft articulated by means of connecting rods, optionally with interposed spring elements, to the clamp ledges.

The invention permits a particularly sensitive, uniform clamping and, prior to the dismantling of a die sleeve, also a corresponding relaxation by active spreading, so that the die sleeve can be widened to such an extent that it is detached from the die cylinder. The clamping device can then be easily removed from the die sleeve slot, i.e. forming a unit, which does not fall apart on removal. When the die sleeve slot becomes free during dismantling, the web still carrying the die cylinder can be circumvented on both sides by the sleeve. This is particularly well ensured by the described construction, because due to the fact that the lateral clamp ledges are only coupled to the frame by spindles running transversely thereto, even after the unit is released from the die sleeve it remains a straight, ledge-like unit. It could either be removed during sleeve replacement or could be raised and remain attached within the machine by means of rings fitted to the entire clamping unit, whereas the sleeve would be axially extracted.

Thus, according to a preferred embodiment in the case of rotary embossing and printing machines, according to the invention the printing dies are preferably fixed to the die cylinder by means of a die sleeve. In order to be able to replace the die sleeve without dismantling the die cylinder said sleeve is slotted and the mounting support of the die cylinder in the machine is such that it can be drawn through and reinserted through a machine frame side plate. It is then fixed to the die cylinder by clamping and for this purpose a separate clamping device is inserted in the die sleeve slot. This clamping device has clamp ledges acting on the die sleeve and which can be clamped towards one another by means of numerous clamps which are mutually axially spaced. The clamps work by means of bosses and connecting members axially displaceable under spring tension by means of a central clamping drive shaft and which shorten the spacing between the clamp ledges by inclining, which takes place in parallelogram-like manner over the entire die cylinder length for the numerous clamps.

Thus, by a single actuation from one of the front ends of the die cylinder, i.e. from the operating or drive side of the machine, clamping and relaxation can be effected.

These and further features can be gathered from the claims, description and drawings and the individual features, either singly or in the form of subcombinations, can be implemented in an embodiment of the invention and in other fields and can represent advantageous, independently protectable constructions for which protection is claimed here. The subdivision of the application into individual sections and also the subheadings in no way restricts the general validity of the statements made thereunder.

### BRIEF DESCRIPTION OF THE DRAWINGS

An embodiment of the invention is described in greater detail hereinafter relative to the drawings, wherein show:

FIG. 1 A cross-section through part of a die sleeve and the clamping device for the same, sectioned along line I-I in FIG. 2.

FIG. 2 A plan view of part of the clamping device in the relaxed state.

FIG. 3 A view corresponding to FIG. 2 in the clamped state.

### DETAILED DESCRIPTION OF A PREFERRED EMBODIMENT

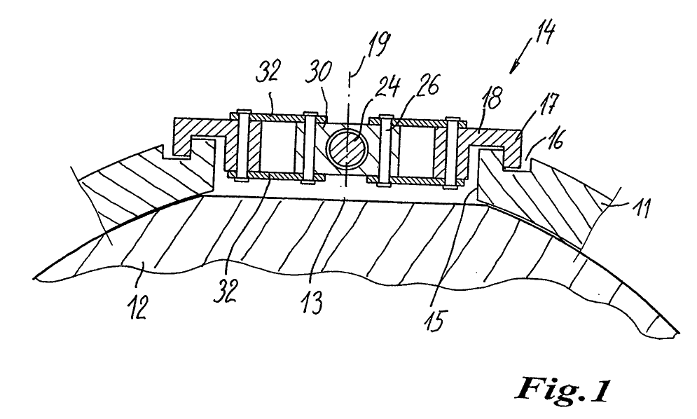

FIG. 1 shows parts of a die sleeve 11 fixed to a die cylinder 12 of a rotary embossing machine. The latter cooperates in a here not shown manner with an impression cylinder and dies fixed to the die sleeve transfer surface portions, e.g. holograms, from a support foil to a printing material, e.g. a paper sheet. For details of the machine, its operation and the construction of the die cylinder and die sleeve, together with the mounting thereof reference is made to DE 196 27 034 C2, whose content for disclosure purposes is fully incorporated into the content of the present application.

The die sleeve 11 has a relatively wide slot 13 making it possible to draw it off axially to one side from the die cylinder 12 in the relaxed state. For this purpose the mounting support of the die cylinder is constructed in such a way that for sleeve change purposes the die cylinder support is only connected by means of a web to the corresponding machine parts and this is somewhat smaller than the width of the slot 13. Following the sleeve change, the die sleeve 11 is again engaged and clamped on the die cylinder 12. For this purpose a clamping device 14, shown in section in FIG. 1, is provided. Following the slot-side ends 15 of the die sleeve 11, the latter is provided on its outside with grooves 16 extending over the entire axial length thereof. Hook-like gripping devices 17 of clamp ledges 18 engage in said grooves 16. Although not absolutely necessary, the groove and the corresponding grip-ping devices can be serrated by corresponding undercuts and projections in order to be able to also positively counteract the centrifugal forces occurring during die cylinder rotation. The clamping device 14 is fully symmetrical to a median plane 19 directed vertically to the die cylinder axis in FIG. 1 and consequently has clamp ledges 18 on both sides.

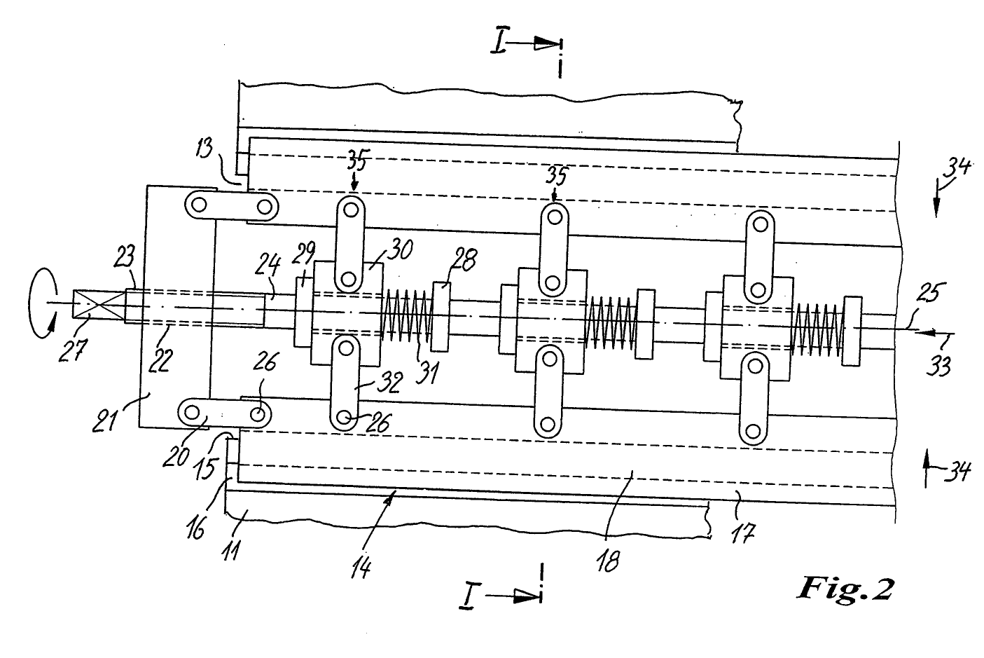

FIG. 2 shows that the clamp ledges 18 are connected by connecting members 20 to a bridge 21, in which is centrally provided a motion-transmitting thread 22, in which engages a threaded portion 23 of a clamping drive element referred to hereinafter as the clamping drive shaft 24. The connecting members 20 run substantially in the direction of the median longitudinal axis 25 of the clamping device and the clamping drive shaft, i.e. also parallel to the axis of the die cylinder and die sleeve. Thus, the clamp ledges 18 are axially substantially fixedly connected to the bridge 21, because the connecting members 20, in the same way as all the other connecting members described hereinafter, are articulated by means of kingpins 26 to the clamp ledges and bridge, which are all directed in the same direction, namely parallel to the median plane 19.

The clamping drive shaft 24, which is provided at its free end with a working or application profile 27, e.g. a square wrench surface for a manual tool, such as a wrench or a mechanical clamping drive, e.g. a screwdriver, runs centrally through over the entire die sleeve length. In mutually spaced manner it has several collars 28, 29, which in each case in axially displaceable manner guide a boss 30. The latter is axially displaceable, but is freely placed on the clamping drive shaft in the rotation direction. Between each of the numerous, longitudinally relatively shortly spaced, successively arranged bosses and the in each case associated collar 28 are provided spring elements 31, usually in the form of a disk spring set and as a result the boss 30 is pressed against the collar 29. In this position, on both sides, each boss is connected by connecting members 32 to the two clamp ledges 18. In this starting position the orientation of the connecting members is at right angles to the axis 25, so that the clamp ledges have the maximum mutual spacing.

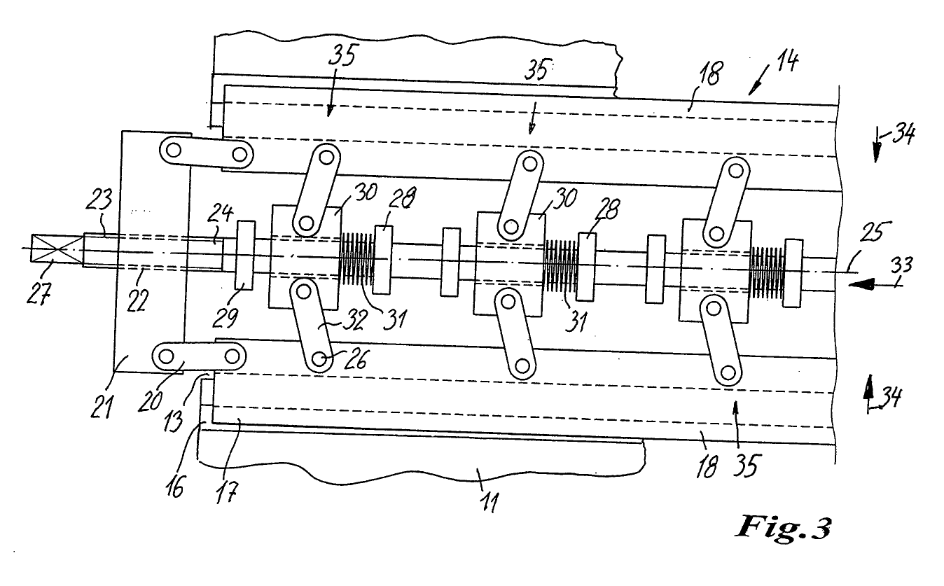

As is shown in FIG. 3, by rotating the clamping drive shaft by means of the working profile 27 the latter is axially moved in the direction of the arrow 33, so that the bosses 30 also attempt to move in this direction and consequently tilt the connecting members 32, which leads to the clamp ledges 18 moving towards one another (see arrow 34). As the clamp ledges 18 are hung by means of the gripping devices 17 in the grooves of the die sleeve 11, they oppose this movement, so that in the manner shown in FIG. 3 the bosses 30 rise from their collars 29 and consequently the pressure thereon is reinforced by means of the spring elements 31. Thus, the spring elements 31 on the one hand ensure a uniform action of all the clamps 35 formed by the bosses 30 and connecting members 32 and on the other for an elasticity reserve in the clamping device adequately counteracting a certain natural tendency of the die sleeve to widen on increasing the size of the slot 13.

The clamps 18 cannot give way in direction 33 as a result of the axial force exerted thereon, because they are connected by connecting members 20 to the bridge 21, which by means of the motion-transmitting thread closes the corresponding circle of forces.

FIG. 1 shows that the bosses 30 are connected by two connecting members 32 with each of the clamp ledges on each of the numerous clamps 35, namely one on the outside and one on the side directed towards the die cylinder 12. Thus, the clamping device 14 forms with the clamp ledges 18 and the central shaft/boss unit an elongated, ledge-like unit, which maintains its shape in the relaxed state. The same applies regarding the articulation of the bridge 21.

The clamping device is used in the following way. If a die sleeve change is imminent, then the clamping device 14 is in the clamped state (FIG. 3). A manual or e.g. electromechanical tool is applied to the working profile 27 and is accessible at the front ends of the die cylinder (operating or drive side). The clamping drive shaft is turned and as a result of the motion-transmitting thread 22, 23 moves to the right counter to arrow direction 33. This increases the spacing between the clamp ledges 18, which enable the sleeve 11, under its natural release force, to widen somewhat and therefore slightly enlarge the slot 13. It then comes free from the tensioning or clamping action on the die cylinder 12 and can be drawn off axially through the measures described in DE 196 27 034 C2. Prior to this the clamping device 14 is raised and either removed or held by not shown means somewhat above the position on the machine shown in FIG. 1, e.g. using rings and hooks.

Following the insertion of a new die sleeve, it is lowered or put into use again, so that the gripping devices 17 again engage in the grooves 16. The clamping device is then in the relaxed or rest state according to FIG. 2. Then by means of the tool and the working profile 27 a rotation takes place on the clamping drive shaft 24, so that it moves in direction 33, i.e. to the left. In the already described manner, through the inclination of the connecting members 32 there is a reduction in the transverse spacing between the clamp ledges 18, so that the sleeve 11 is fixed on the die cylinder. The clamp ledges 18 move with respect to the bridge 21 in a limited and scarcely perceptible manner, because they tilt somewhat (cf. FIG. 3). As a result of the spring elements 33 this clamp state is maintained, even if as a result of external influences, e.g. thermal expansion of the die sleeve 11 on the heated die cylinder 12, there is a change to dimensions and positions.

Thus, a possibility is created using a simple mechanical device to simultaneously effect a powerful clamping tension of the die sleeve on the die cylinder, without the corresponding tools having to be too bulky, so that e.g. only two clamping devices 35 would be required over the length. It must be ensured that the clamping device remains on the die cylinder during the rotation thereof and must therefore also be incorporated into the balancing. Another advantage of the device is that the centrifugal forces which occur do not influence the clamping force.

1. Clamping device for fitting a die sleeve (11) to a die cylinder (12) of a rotary cylinder press, in which the die sleeve (11) provided with a lengthwise slot (13) is replaceably clamped to the die cylinder (12) by means of the clamping device (14), which is provided with a clamping drive acting over the length of the die sleeve and centrally operable from at least one front end of the die cylinder (12), the clamping drive having a clamping drive element (24) and several clamping elements (35) operable by the clamping drive element (24), the clamping device (14) being a component removable in the relaxed state from the die cylinder (12) and the die sleeve (11).

2. Clamping device according to claim 1, wherein the clamping drive element (24) acts under spring force on the clamping elements (35) by means of a separate spring element (31).

3. Clamping device according to claim 1, wherein the clamping elements (35) are operable by the clamping drive element (24) acting as a push rod optionally displaceable by a screw drive and the clamping elements (35) have a reversing gear for reversing a longitudinal movement into a substantially circumferentially directed clamping and tensioning movement.

4. Clamping device for fitting a die sleeve (11) to a die cylinder (12) of a rotary cylinder press, in which the die sleeve (11) provided with a lengthwise slot (13) is replaceably clamped to the die cylinder (12) by means of the clamping device (14), which is provided with a clamping drive acting over the length of the die sleeve and centrally operable from at least one front end of the die cylinder (12), the clamping drive having a clamping drive element (24) and several clamping elements (35) operable by the clamping drive element (24), the clamping device being connectable to the die sleeve (11) on both sides of the slot (13) by means of clamp ledges (18) extending over the length of said die sleeve (11), the die sleeve being clamped and tensioned on both sides directly by the clamping device.

5. Clamping device according to claim 4, wherein the clamping elements (35) are operable by the clamping drive element (24) acting as a push rod optionally displaceable by a screw drive and the clamping elements (35) have a reversing gear for reversing a longitudinal movement into a substantially circumferentially directed clamping movement.

6. Clamping device for fitting a die sleeve (11) to a die cylinder (12) of a rotary cylinder press, in which the die sleeve (11) provided with a lengthwise slot (13) is replaceably clamped to the die cylinder (12) by means of the clamping device (14), which is provided with a clamping drive acting over the length of the die sleeve and centrally operable from at least one front end of the die cylinder (12) or the machine, the clamping drive having a clamping drive element (24) and several clamping elements (35) operable by the clamping drive element (24), said clamping elements (35) being constructed in the manner of a toggle lever drive with in each case at least two flat, pivotably articulated connecting members (32), in which a stretched or mutually aligned orientation of the connecting members (32) provides an open position of the clamping device and a deflected position a clamping position and in which the clamping device is mainly received in the slot (13) of the die sleeve (11) and if necessary takes up a shallow recess in the die cylinder (12).

7. Clamping device according to claim 6 wherein each of the clamping elements (35) has a movable boss (30) located on the clamping drive element (24) and optionally movable to a limited extent with respect thereto and on which are pivotably articulated connecting rod-like connecting members (32), which are also pivotably articulated to the clamp ledges (18) and at least transfer tensile forces and preferably also compressive forces.

8. Clamping device according to claim 7, wherein the bosses (30) are axially displaceable via spring elements (31) from stops (28) on the clamping drive element (24) and in the unloaded position engage on stops (29) on the clamping drive element (24).

9. Clamping device according to claim 6, wherein the clamping drive element (24) is guided in a bridge (21) and is axially movable by means of a motion-transmitting thread (22, 23), the bridge (21) being located in the vicinity of a front end of the die cylinder (12) and is substantially firmly coupled axially to the clamp ledges (18), but allows radial movements of the clamp ledges (18).

10. Clamping device according to claim 6, wherein in the vicinity of a front end of the die cylinder (12), the clamping drive element has a key face (27) for an adjusting drive.

11. Clamping device for fitting a die sleeve (11) to a die cylinder (12) of a rotary cylinder press, in which the die sleeve (11) provided with a lengthwise slot (13) is replaceably clamped to the die cylinder (12) by means of the clamping device (14), which is provided with a clamping drive acting over the length of the die sleeve and centrally operable from at least one front end of the die cylinder (12), the clamping drive having a clamping drive element (24) and several clamping elements (35) operable by the clamping drive element (24), in which the clamping device can be connected to the die sleeve (11) on either side of the slot (13) by means of clamp ledges (18) extending over the length of said die sleeve (11), so that the latter is directly tensioned on both sides by the clamping device, the clamping elements (35) being constructed in the manner of a toggle lever drive with in each case at least two flat, pivotably articulated connecting members (32), in which a stretched or mutually aligned orientation of the connecting members (32) gives an open position of the clamping device and a deflected position a clamped position, and in which the clamping device is mainly received in the slot (13) of the die sleeve (11) and if necessary occupies a shallow recess in the die cylinder (12), the clamping device (14) being a component removable in the relaxed state from the die cylinder (12) and die sleeve (11).
